(19) United States
(12) Patent Application Publication
(10) Pub. No.: US 2009/0018908 A1
(43) Pub. Date: Jan. 15, 2009

(54) ELECTRONIC COUPON DEVICE

(76) Inventor: Oksana Dersovitz, Highland Park, NJ (US)

Correspondence Address: VIDAS, ARRETT & STEINKRAUS, P.A., SUITE 400, 6640 SHADY OAK ROAD, EDEN PRAIRIE, MN, 55344, US

(21) Appl. No.: 11/777,015

(22) Filed: Jul. 12, 2007

(51) Int. Cl. G06Q 30/00; G06F 17/30

(52) U.S. Cl. 705/14

(57) ABSTRACT

A paperless online system is provided consisting of issuance of a PVC magnetic stripe Coupon Card to retail customers (cardholders) upon registration and Electronic Coupons, linked to a Coupon Card by cardholders via networks of personal computers or other devices. Each Electronic Coupon is descriptive data supplied by product Manufacturer or Service Provider, electronically stored in a Central Database, and is formatted to be displayed online for browsing and selection. Coupon data specifically describes instructions and discount amounts pertaining to the Electronic Coupon, UPC codes to which it applies, effective and expiration dates, as well as the number of Electronic Coupon instances to be issued in total and to each individual customer. Each Electronic Coupon can be linked to a card of any cardholder interested in receiving the discount designated by the Electronic Coupon. Electronic Coupon does not contain a barcode and does not need to be printed out in order to be redeemed. Retail Merchant's Point of Sale method is provided for Electronic Coupon redemption. It entails handling the transaction initiated with the Coupon Card as a type of payment, in order to provide appropriate discounts to cardholder. Multiple products or services can be discounted per each card swipe, corresponding to the Electronic Coupons linked to that card. The backend central processing method and system is provided, including the following: importing Electronic Coupon data into the Central Database, Coupon Card transaction receiving, processing and returning the result to Merchant's Point of Sale terminal, Manufacturer or Service Provider settlement and billing process, retail Merchant settlement and funding process.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

In some embodiments this invention relates to devices for and methods of financial data processing and management of issuance, redemption, and settlement of electronic coupons, tickets, and vouchers.

2. Description of the Related Art

Coupons are defined as rights that entitle their bearer or owner to certain benefits, such as a discounted price for goods and services, a cash refund, or a gift. Such coupons are often issued by vendors in order to attract attention, encourage the purchase of their wares, or maintain consumer loyalty to a product or vendor. Similarly, consumers value coupons for their worth and convenience.

Traditionally coupons were paper certificates that either were issued to potential or prior consumers or could be detached from a newspaper or other paper sources. Recently electronic coupons in the form of gift cards and downloadable printouts have become ubiquitous as well. Both paper and electronic coupons however suffer from a number of drawbacks. Paper and printout coupons are cumbersome and are subject to wear out. Printed downloaded coupons (like all barcode-based coupons, printed or cut-out), are also particularly vulnerable to forgery. Electronic coupons are often linked to a single vendor or become rapidly expired.

All of these coupons are also subject to becoming lost, misplaced, or just not being available when a consumer would like to use the coupon. Consumers often become irritated by these drawbacks which often convert the would-be consumer goodwill into disappointment and frustration from lost anticipated benefits. Vendors in turn may face the dilemma of choosing between maintaining customer goodwill by incurring losses when they honor invalid coupons or loosing goodwill by enforcing coupon rules.

One unsatisfactory form of coupon is the electronic coupon card such as that described in U.S. Pat. No. 6,691,915. This coupon system imposes all of the recordkeeping onus on the vendor including the burden of keeping track of which coupons were issued by which manufacturers, whether they are or are not valid and if they will or will not be reimbursed by the manufacturer or wholesaler. It also requires that separate records be kept for each product or manufacturer represented by the coupon. These complexities limit their value to vendors and increase the likelihood of either vendor losses or, consumer frustration.

Another unsatisfactory form of coupon is one which contains a bar code which is downloaded and printed out as described in U.S. Pat. No. 6,708,208. This coupon system is subject to fraud because multiple copies of the bar code can printed. It also is dependent on the consumer having access to a printer of sufficient quality to generate a bar code which can be properly scanned. Either of these two flaws could result in coupons which would not be accepted by vendors. Lastly it is prone to fraud because there is no direct association between a specific consumer and a specific discount inviting the fraudulent presentation of coupons to manufacturers without any true discounted transaction having occurred. Other unsatisfactory coupon systems can be found in U.S. Pat. Nos. 5,761,648, 6,697,785, and 6,694,300.

For at least these reasons there is a need for an improved coupon device or system. The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

### BRIEF SUMMARY OF THE INVENTION

At least one embodiment of the invention is directed to a paperless centralized system of fraud-resistant Electronic Coupon issuance, distribution, redemption and settlement.

At least one embodiment of the invention is directed to a process of consumer Internet account signup and release of personal profile data to the Central Database. The process, then details issuance of a physical PVC Magnetic Stripe Card (similar to credit card) and usage of the Internet account to link/download desired Electronic Coupons or service discounts onto their unique account which is represented by a physical card.

At least one embodiment of the invention is directed to a method for the Manufacturer or Service Provider to periodically import Electronic Coupon data to the Central Database for consumer browsing, selection and redemption.

At least one embodiment of the invention is directed to a system is designed for consumer redemption of Electronic Coupons at Merchant's Point Of Sale, via swiping the Coupon Card through an existing card reader and sending a transaction request to the Central Processor. The system design includes the central transaction processing system, which receives and validates the transaction, computes the total Electronic Coupon redemption amount, and responds back to Merchant's POS.

At least one embodiment of the invention is directed to a method of billing, funding, and reconciliation between Merchants and Manufacturers/Service Providers, which is done through the Central Processor.

At least one embodiment of the invention is directed to a process for an external entity as permitted by law, to request demographic, promotional, sales, product desirability, or any other report. The reports are generated based on the data stored in the Central Database, and then distributed to the external entity periodically or on demand, as requested.

This and other aspects of the invention are described in more detail in the accompanying description and drawings,

### BRIEF DESCRIPTION OF THE SEVERAL VIEWS OF THE DRAWINGS

The invention is best understood from the following detailed description when read in connection with accompanying drawings, in which:

FIG. 1A is a relational diagram of all elements participating in the Electronic Coupon System. Each relating connection in this diagram is further detailed in separate drawings as indicated.

FIG. 1B is a flowchart of consumer actions carried out in order to sign up for Electronic Coupon Card account, receive a physical PVC Coupon Identification Card, and be able to download Electronic Coupons onto the card/account.

FIG. 1C is a drawing, measurements and the specifications of a coupon card.

FIG. 1D is a relational diagram of the interaction between a merchant and the central entity.

FIG. 2 is a relational diagram of an Electronic Coupon import process from manufactures into the central location database.

FIG. 3A is a flowchart of an Electronic Coupon redemption process at Merchant's Point of Sale (POS).

FIG. 3B is a flowchart of the Financial Transaction processing system.

FIG. 4A is a flowchart of the central Manufacturer billing and reconciliation system.

FIG. 4B is a flowchart of the central Merchant funding and reconciliation system.

### DETAILED DESCRIPTION

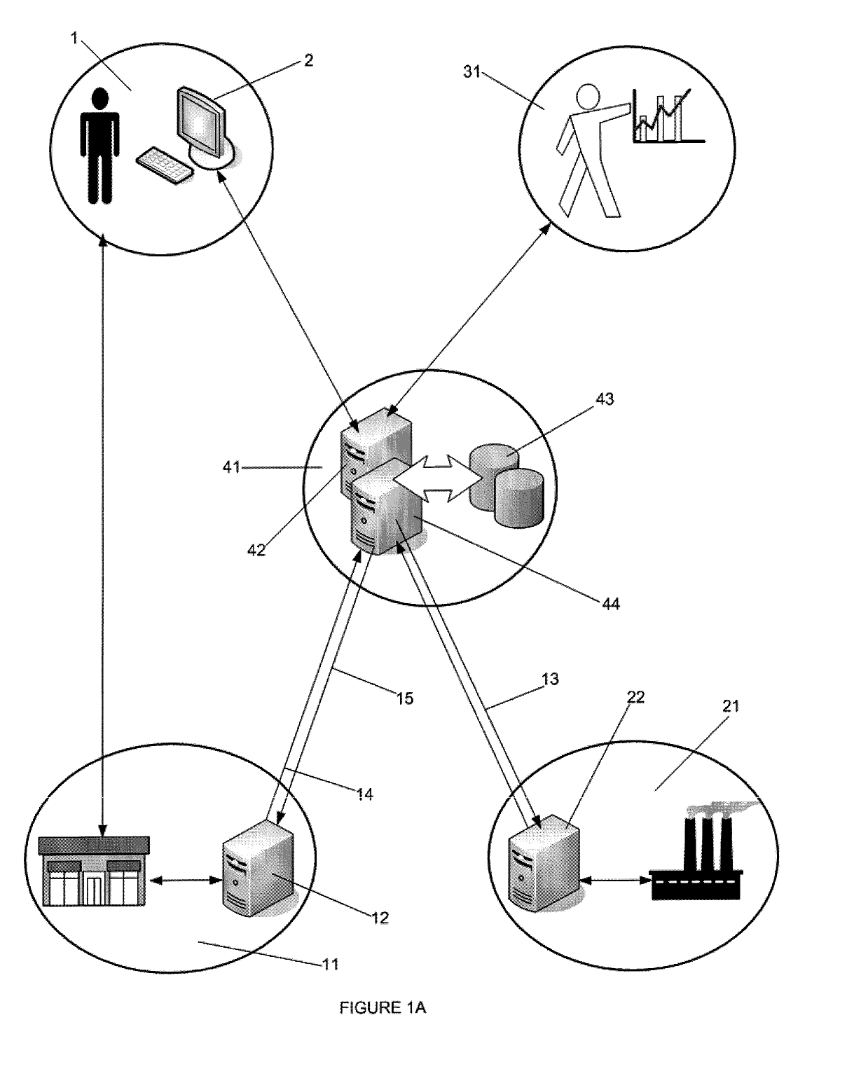

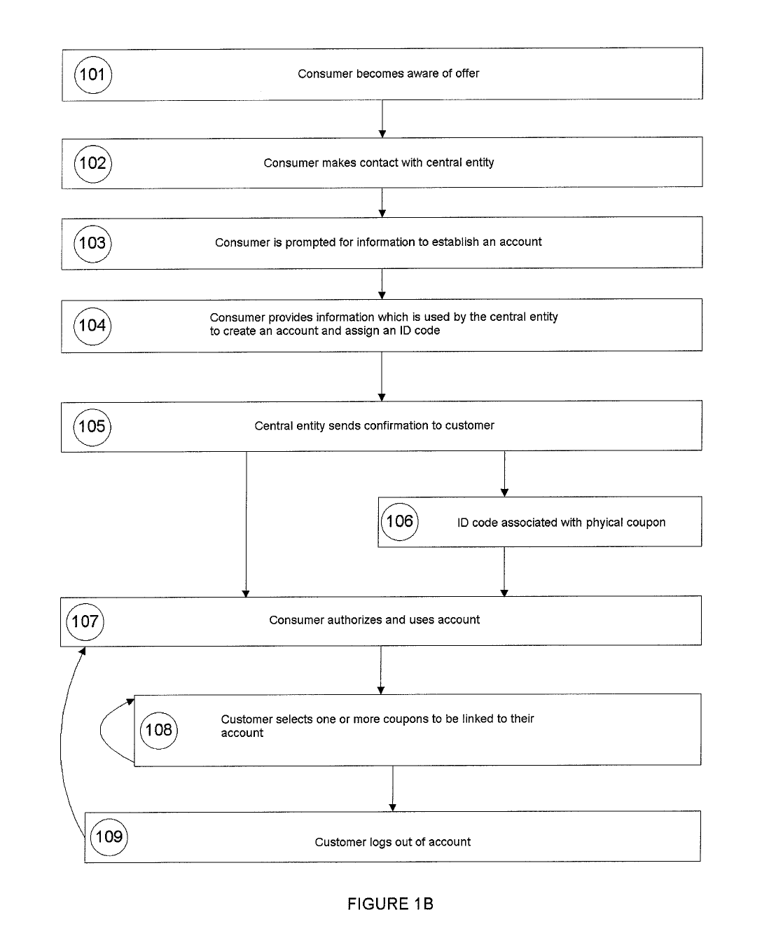

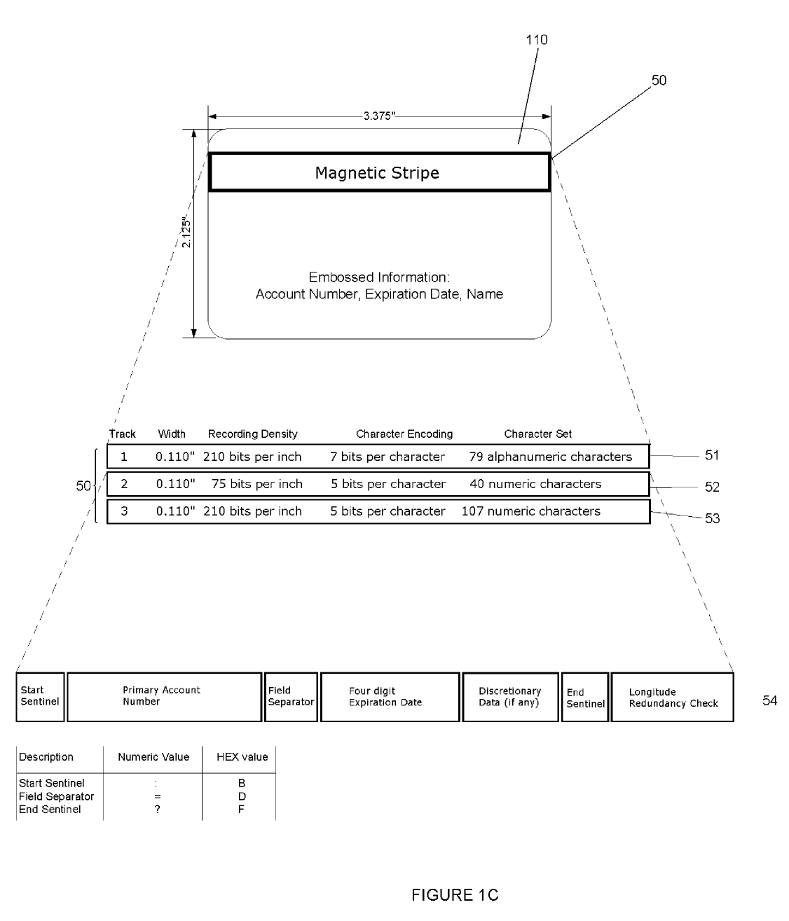

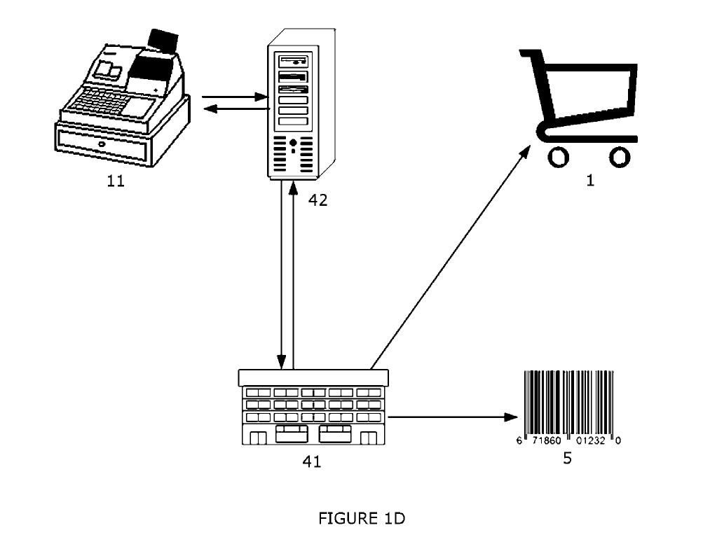

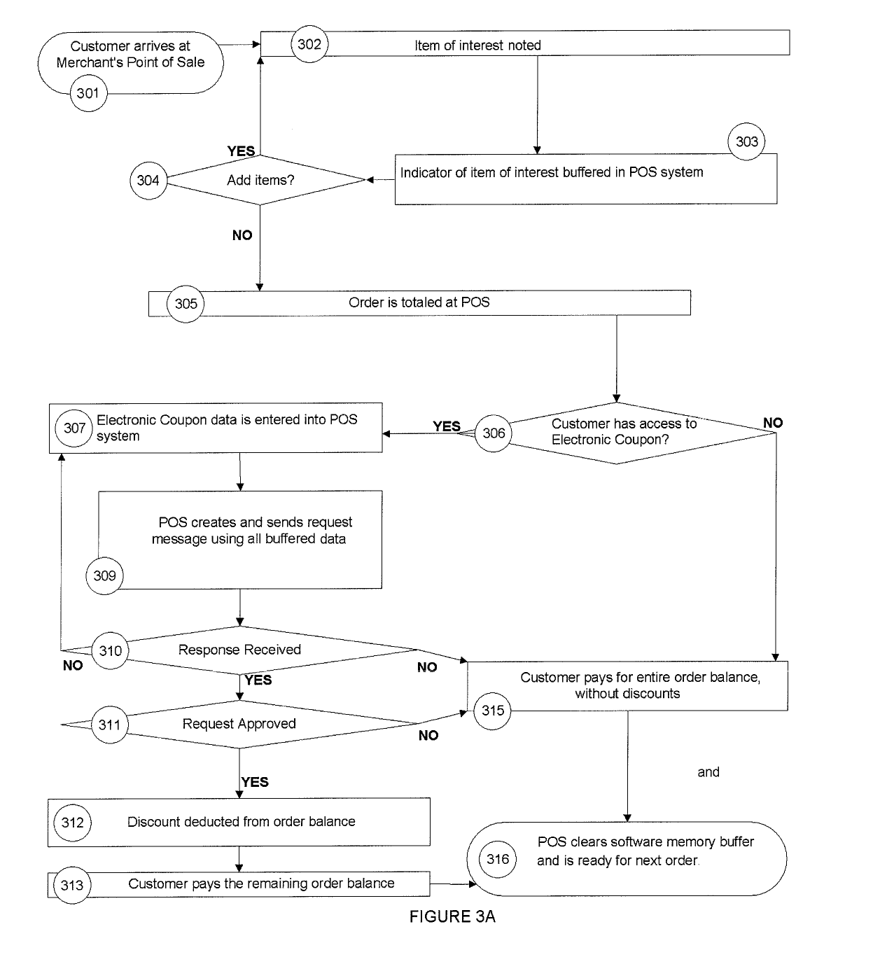

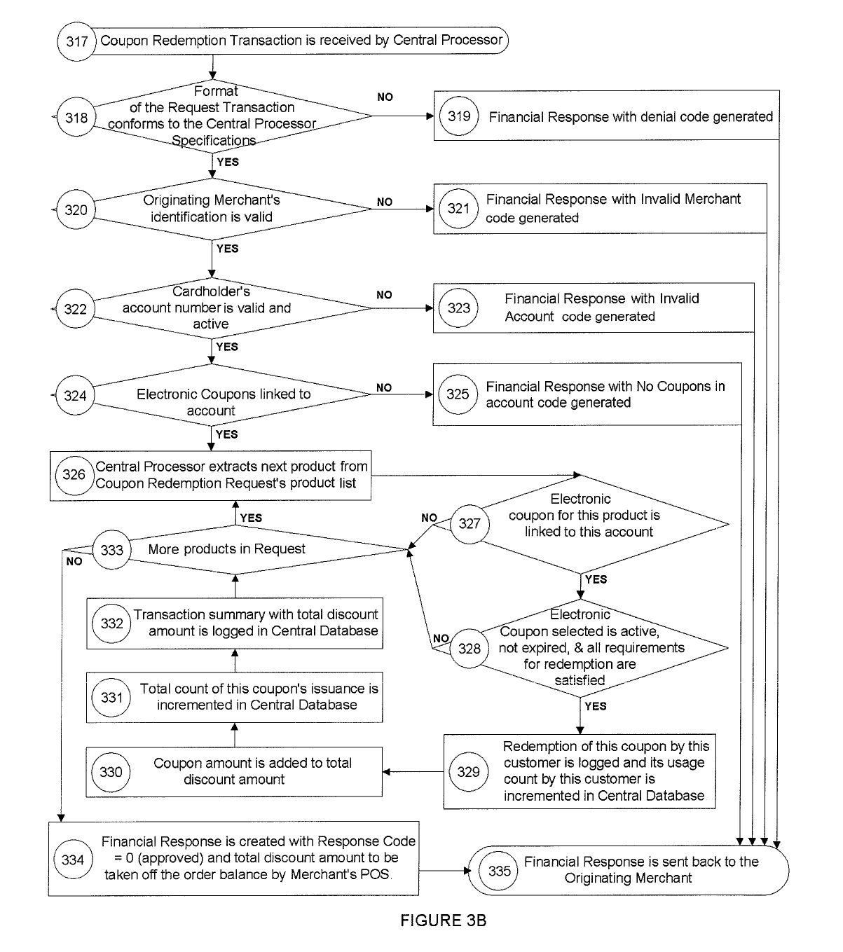

Referring now to FIG. 1A, there is shown the interactive relatedness of the various parties involved in the inventive electronic coupon system, A consumer (1) can interact with a merchant (11) via a mortar store, online purchase, or any other method known in the art to purchase a product (5 in FIG. 1D). The consumer (1) can either interact with the merchant (11) to redeem an electronic coupon (through the process illustrated in FIG. 3A). Alternatively, the consumer can deal directly through a central entity (41) (through the process illustrated in FIG. 1B) to utilize the electronic coupon. Similarly, External entity processors (31) and manufacturers (21) interact with through the central entity (41). Each of these interactions, are described in detail as follows:

Referring now to FIG. 1B, there is shown an overview of at least one process a consumer can undergo to participate in the electronic coupon system. A consumer first becomes aware of a coupon or discount being offered (Step 101). This awareness could be a result of some form of referral including but not limited to advertisements, publications, magazines, mailings, promotions, word of mouth, other media, and any combination thereof, or through other methods. When informed of the offer, the consumer is also instructed to make contact with the central entity (41 of FIG. 1A). This contact can be done in person, by mail, telephone, e-mail, or ideally by logging onto a designated webpage via an internet browser (Step 102). In at least one embodiment, the advertisement itself is a webpage or leads to an advertisement webpage which itself links to the central entity (41 of FIG. 1A).

If the consumer is accessing the central entity (41 of FIG. 1A) for the first time, the central entity will prompt the user for login information needed to establish an account (Step 103). The consumer then provides the entity with the required information to establish an account and the account is created. In at least one embodiment, this information is entered into text boxes displayed on a webpage. In at least one embodiment, the information is received by a central entity web server which through a processor (44) inputs the data into a database (43). (Step 104). In at least one embodiment a pre-generated or simultaneously generated certificate file such as Exchange Certificate File or (ecf file) is uploaded to provide the central entity with registration information. In at least one embodiment a confirmation is then issued by the central entity. (Step 105). This confirmation can be an e-mail, mailing, telephone, facsimile, or the like, or any combination thereof.

Once sufficient information has been collected by the central entity, a consumer account is generated. One part of the consumer account is a consumer profile. The profile includes information such as name, mailing address(es), email address(es), product preferences, and optional or personal data, including but not limited to age, ethnicity, household income, consumer preferences, family members, contacts, shopping history, and the like. In at least one embodiment, the central entity will seek out and add information to the profile from other data sources such as referrals from other consumers or vendors, or other data sources such as legal data mines and the like. In at least one embodiment, the profile is managed by a central processor (44) and is stored in one or more databases (43) of the central entity. In at least one embodiment, limits are imposed on the collection and retention of profile data to assure compliance with legal record keeping, confidentiality, and privacy laws, or polices of the central entity.

Once the account has been generated, an identification code is assigned to the consumer. In at least one embodiment, the identification code or a value related to it in a database is embedded within or associated with one or more physical coupons. (Step 106). In at least one embodiment the physical coupon is a credit card type card with a machine readable or visibly readable identifier on it. In at least one embodiment, this identifier can be at least one selected form the list consisting of magnetic, digital, bar code, or similar strip or area extended across a portion of a rectangular card or other shape of material, or any combination thereof. In at least one embodiment the physical coupon is constructed out of PVC and/or another polymer. In at least one embodiment, the physical coupon looks similar to a typical credit card.

Physical coupons can also be transponder type ETC (electronic toll collection) or EZ Pay type devices and/or data storage card type devices such as portable USB drives. More than one physical coupon and more than one kind of physical coupon can be issued for an account. In at least one embodiment, the information in the profile determines at least in part which kind of physical coupon will be issued for the account. In at least one embodiment, no physical coupon is created for an account, and the information is related either to the identity of the consumer, to biometric information of the consumer, to the identification code associated with the consumer, to some unique or rare identifier, or some combination thereof. In at least one embodiment, a single unique physical coupon is issued to the consumer. In at least one embodiment, when only a single physical coupon is issued to the consumer, replacing a lost physical coupon will result in the previous physical coupon being disabled (virtually or physically) from further use.

Whether utilizing physical and/or non-physical coupons, once the account is created, the consumer can authorize the use of the account (step 107). In at least one embodiment, account authorization is accomplished by logging into the central entity via the internet. In at least one embodiment, this is accomplished by replying to a activating a link in an e-mail generated by the central entity when the account is created.

In at least one embodiment, personal information (such as demographic data) is utilized to mail the consumer promotional material and to generate sales and survey reports. In addition, the personal information is validated and cross referenced to prevent false or multiple accounts from being opened. In at least one embodiment, the central entity has access to and utilizes credit scoring data to validate the identity and authenticity of an account or profile. The existence of an identification code can be registered as other credit information is registered preventing the generation of duplicate identification codes.

In at least one embodiment, the physical coupon (3) associated with an account is a card (110) conforming to ISO/IEC 7810-7811 standards, as illustrated on FIG. 1C. In at least one embodiment the card has a width of 2.125 inches and a length of 3.375 inches. Customer's name and expiration date can be embossed on the front of the card (110). The card (110) comprises one or more magnetic tracks (50). In at least one embodiment, there are three magnetic tracks, track I (51), track II (52), and track III (53).

In at least one embodiment, one or more tracks (50) are 0.110 inches wide. The tracks can have a recording density of between 1 bit/inch and 300 bits/inch, 5-32 bits/character and a character set of 20-200 alphanumeric characters. In at least one embodiment track I (51) has one or more of the following features: a record density of 210 bits/inch, a character encoding of 7 bits/character, and a character, set of 79 alphanumeric characters. In at least one embodiment track II (52) has one or more of the following features: a record density of 75 bits/inch, a character encoding of 5 bits/character, and a character set of 40 numeric characters. In at least one embodiment track III (53) has one or more of the following features: a record density of 210 bits/inch, a character encoding of 5 bits/character, and a character set of 107 alphanumeric characters. Magnetic stripe Track II can be encoded to contain the account number and expiration date matching to the embossing on the front.

In at least one embodiment, once the consumer has successfully registered an account with the central entity, the consumer is informed to expect the arrival of the card within 7-10 business days by mail or shipment. (Step 112). In at least one embodiment, once the consumer has successfully registered an account with the central entity, the card actually arrives within 7-10 business days by mail or shipment. In at least one embodiment, once the account is created the demographic and other personal profile information can be used to generate sales and lead reports and to direct advertising.

In at least one embodiment, immediately upon establishing an account, the user is given a passcode. The passcode can be an alphabetic and/or numeric sequence, and/or a downloadable file such as an Exchange Certificate File or ecf file or the like. Once given a passcode, the consumer can immediately utilize their coupon account without needing to await the arrival of a physical coupon. The passcode can be utilized to log into the central entity during subsequent sessions and can be changed by the customer or central entity as required or is convenient. The passcode can be used when prompted in both brick and mortar stores as well as for online and internet purchases. In at least one embodiment, vendors can access the account of a particular customer by their being given personal information by that consumer and cross referencing the supplied information with data stored in the account profile.

In at least one embodiment, the consumer can log in to the central entity via a computer or internet connection and can browse and select desired Electronic Coupons (FIG. 1B Step 107). When a customer is logged into their account, the Electronic Coupons and service discounts can be presented at random or sorted by one or more categories so as to be easily searched. In at least one embodiment, the central entity utilizes profile information to select which coupons are displayed to the consumer and sorts them according to perceived interest by the consumer. In at least one embodiment, when logged into the account, the consumer can provide the central entity with ratings of their personal opinion of the value of each of the various coupons which the system offers them. The system in turn can us those ratings to update the customer's profile and better anticipate future consumer interests and tastes.

Each Electronic Coupon is a collection of data such as Manufacturer or Service Provider, product(s) or service(s) discounted, the amount of discount, and the rules/regulations of discount (if any) such as number of Electronic Coupons allowed per household, expiration dates, etc. Customer can select desired Electronic Coupons and those selected become linked to their account. In at least one embodiment, the central entity's website displays a button which when clicked links (FIG. 1B Step 108) the selected Electronic Coupons to their account. Electronic Coupons can be selected individually or by entire category or sub-category of products/services. Electronic Coupons can be “de-selected” if no longer desired. In at least one embodiment, automatic filtering of expired Electronic Coupons on each customer's account will be performed periodically by the Central Processor. In at least one embodiment electronic coupons are automatically added to a consumer's account without any action by the consumer. When a consumer finishes their logged on session, they can either manually log out of the system or be automatically logged off of the system. (FIG. 1B Step 109).

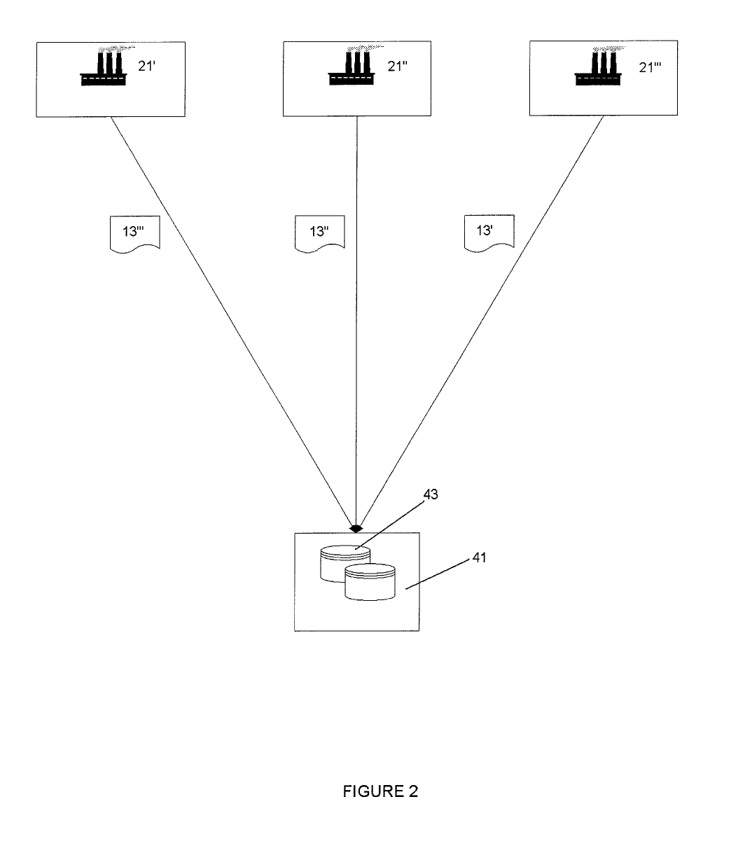

Selected Electronic Coupons can be redeemed by using a physical coupon or non-physical coupon (such as a passcode or profile information) at any participating retailer carrying the specified products or services. In at least one embodiment of the invention, the Electronic Coupon data displayed on the central entity's (41) website is obtained directly from Manufacturers or Service Providers who are interested in reducing their cost of processing paper or other coupons as well as getting better-quality data about their products and consumers. A method and process contemplated by this invention to receive and import Electronic Coupon data, as detailed on FIG. 2. In at least one embodiment of the inventive concept, manufacturers (21), vendors, or merchants (11) post discount offers or terms to other vendors, merchants (11), or manufacturers (21) which can be accepted by auction at the central entity (41). In at least one embodiment, electronic coupons can only be redeemed if the customer has a coupon card handy at the Point of Sale.

As illustrated in FIG. 2, at some point, each participating Manufacturer (21, 21′, 21″, 21′″) or Service Provider can compile a formatted list (13, 13′, 13″, 13′″) of new Electronic Coupons. In at least one embodiment, the terms of the service provider or manufacturer's participation in the Electronic Coupon System include an obligation to update the list at regular intervals. Each item in the list contains attributes of an Electronic Coupon including but not limited to: product and/or service UPCs, name, description, graphic image of product, discount amount, description of the rules, start and expiration dates, and the number of instances the Electronic Coupon can be issued to one household and in total and transferred to the central entity. In at least one embodiment, at least some of the attributes may be encoded with special codes. In at least one embodiment, the list is encrypted.

In at least one embodiment the list is transferred to the central entity electronically such as by File Transfer Protocol and/or E-mail and/or the like, based on the agreement between the Manufacturer and the Central Processor (114). In at least one embodiment, the receipt of such a list by the central entity automatically triggers the upload of each item into the Central Database (115). Upon successful upload to the database, each new Electronic Coupon is automatically viewable for customer's browsing and selection. In at least one embodiment, one or more validation steps are conducted by the central entity (41) before an updated list is available to consumers.

In at least one embodiment of the invention, the Electronic Coupon redemption process is provided by this invention and is detailed on FIG. 3A. Transaction format is provided in FIG. 3C and FIG. 3D. The redemption process requires actions from both the consumer and the POS/retail store controller software.

A consumer with an account may shop for any items at the Merchant's store, whether with or without intent on redeeming a particular set of Electronic Coupons (Step 301). For easy reference at the store, a website holding a consumer's Internet account provides the ability to print current list of Electronic Coupons linked to their account. At the Point of Sale (POS), the vendor notes the products being purchased. This may be done by a clerk or self-checkout and can involve scanning items' UPC with a digital or analog scanner (Step 302). In at least one embodiment, the system can automatically apply a coupon at the Point of Sale without the consumer first selecting it to their account. In at least one embodiment, scanned UPCs are buffered (step 303) by the Point Of Sale software until the order is tendered. This can be repeated as appropriate. (Step 304).

When all items are noted (Step 305), the order is totaled (by a clerk, by software, and/or their equivalent) and the total can be displayed. If the customer does not have access to their electronic coupons, the order can be cleared. (Step 315). Lack of access to an electronic coupon can be the result of not having a coupon card handy, not remembering an identifier or passcode, or other technical problem. Clearing the order can comprise clearing or flushing the buffer containing UPC codes (Step 316). If the customer has access to an electronic coupon, the account must be accessed. In at least one embodiment the account is accessed by the customer or a clerk by swiping or key entering a Coupon Card or other identifier. (Steps 305-306). In at least one embodiment, the electronic coupon must be entered as a first type of tender, using a card reader already present at the store for credit/debit/EBT card transactions. The electronic coupon can be entered before or after the order is totaled. In at least one embodiment of a coupon card type electronic coupon, the information from one or more of the tracks of the coupon card is read by the card reader and inserted into an outgoing request for authorization (Step 309). In at least one embodiment, this information is contained at least or in total within track II.

The Merchant's controller or switch software formats a Financial Request message (14 in FIG. 1A) based on the Central Processor's specifications which will be sent to the central entity (as shown in FIG. 3C). In at least one embodiment, this request conforms to with ISO 8583 Financial Transaction Message standards. The request consists of information needed to indicate a pending coupon discounted sale including but not limited to: account number, expiration date, total order amount, local date and time, System Trace Audit Number (generated by POS software), POS entry mode (code indicating whether the card was swiped or key-entered), Merchant Category Code, which identifies the Merchant type based on ISO 18245, POS terminal identification, Merchant's identification, and all the UPCs that were buffered during the scanning process. After formatting, the Financial Request message is sent to the Central Processor for approval.

The central entity in turn replies with a Financial Request Reply (15 in FIG. 1A) which will contain denial, approval, or some other reply to the Financial Request message. (Step 311). In at least one embodiment, a denial reply includes descriptive denial code, which Merchant's controller or switch must translate into descriptive POS response code according to their company policy. In at least one embodiment, an approval reply includes approval code of zero and the amount that should be taken off the order balance in lieu of redeemed Electronic Coupons. POS software or a clerk can deduct this amount from the order balance (Step 312). The order is then tendered according to customer's wishes (Step 313).

Referring now to FIG. 3B there is shown steps taken by the central entity processor when processing a received (Step 317) financial request (14 in FIG. 1A). Incorrectly formatted transactions are returned to Merchant with a “General denial” code (Step 318-319). Merchants that are not configured in the system or do not have a correct Merchant identification number in the message, are denied with “Invalid Merchant” code (Step 320-321). Consumer accounts that do not exist, are expired, or are in status other than active, are returned to Merchant with “Invalid Account” denial code (Step 322-323). If there are no Electronic Coupons linked to the cardholder's account, the transaction response will indicate “No Coupons Per account” (Step 324-325). In at least one embodiment, each unsuccessful transaction is recorded in the Central Database for troubleshooting, customer inquiries or third-party report purposes.

If there are unredeemed active Electronic Coupons linked to the account, the Central Processor goes through the list of provided product identifiers or UPCs of the purchases and tries to match them to Electronic Coupons linked to the account (Step 326 and 333). The values of matching Electronic Coupons are summed up. The total is sent back in the Financial Response as the authorized amount to be taken off the original order (Step 334). The approved or denied transaction is sent back to the originating Merchant's controller or switch (Step 335). In at least one embodiment, the redeemed Electronic Coupons are marked as such in the account. In at least one embodiment, a timestamp of redemption and some or all of the other details of the transaction are also recorded in a transaction log.

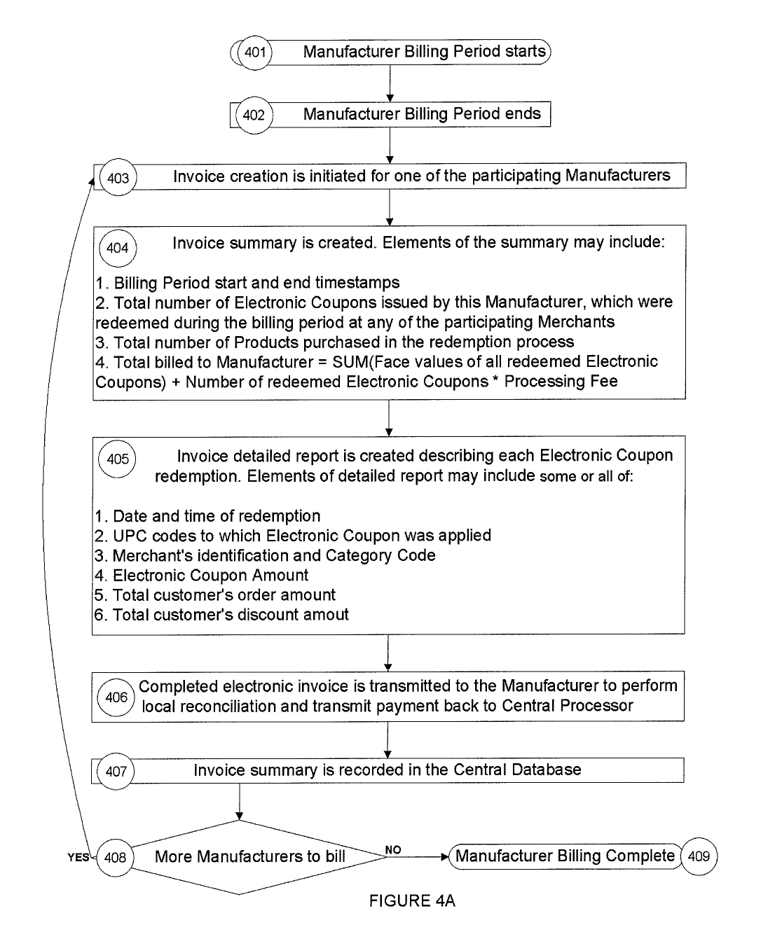

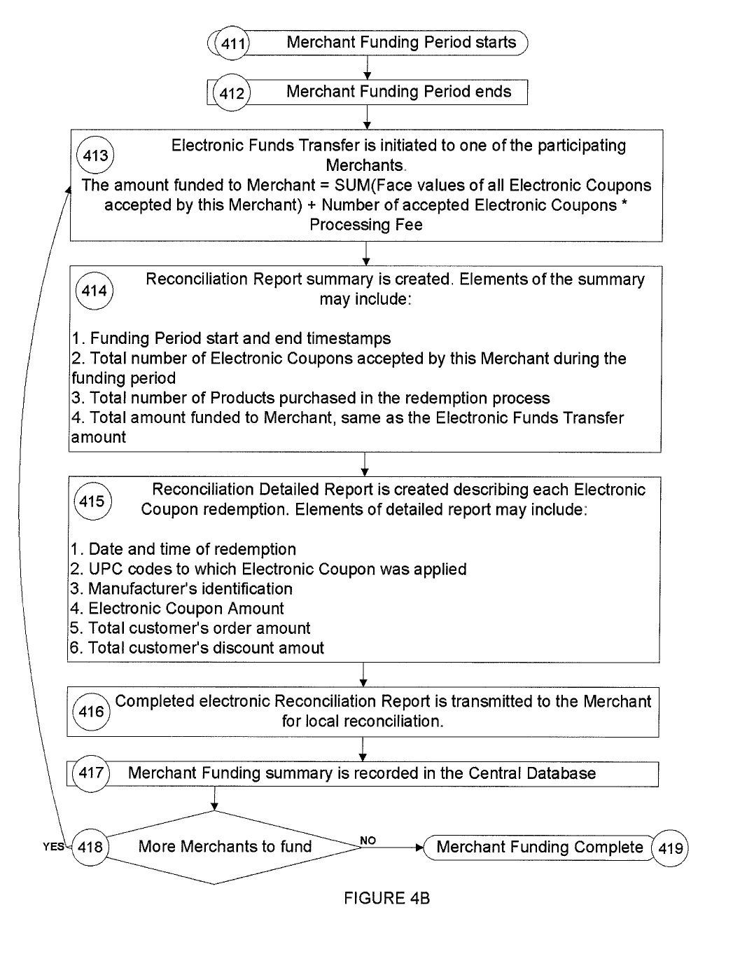

In at least one embodiment of the invention, the Electronic Coupon value reimbursement and settlement process between Merchants and Manufacturers is provided by this invention. Fund settlement is initiated and completed by the Central Processor as specified in FIG. 4A and FIG. 4B.

Manufacturers participating in the Electronic Coupon System are billed for the face value of the redeemed Electronic Coupons. In at least one embodiment, a processing fee is added to the bill. A common current practice is to charge an 8¢ fee per coupon processed. The electronic coupon system can include such a fee structure or can include a lower or higher fee, or assess a fee related to coupon dollar values, flat fee, or other criteria. The fee is agreed to by the manufacturer. (Step 401-402). The billing is based on the transaction records stored in the Central Database. Instead of receiving a package of redeemed paper coupons from each Merchant for reimbursement as is currently done in the art, each Manufacturer receive one electronic invoice for one or any number of coupons redeemed. In at least one embodiment only one bill is issued per period. (Step 403 and 404). Bills contain information including but not limited to summary and details of their Electronic Coupon redemption history grouped by Merchant. (159). The bill includes a billing period summary such as the number of Electronic Coupons redeemed and the number of products purchased to redeem Electronic Coupons.

A detailed report of each Electronic Coupon redeemed is also provided with the bill (Step 405), including but not limited to the date and time of each redemption, UPCs or product identifiers to which the Electronic Coupon was applied, Merchant's identification and category code, Electronic Coupon amounts, and order and discount total amounts. In at least one embodiment the report is redacted, edited or otherwise modified to prevent the inclusion of confidential information from going onto the bill. In addition to the benefits of central billing entity, the electronic invoice format allows Manufacturer to manipulate the invoice report data for marketing or internal reporting purposes without manual data entry.

In at least one embodiment, Merchants are funded for at least some to all of the face value of the Electronic Coupon accepted and can also be paid none, some, or the entire processing fee charged to a Manufacturer issuing that Electronic Coupon. (At least none, some, or all, of the processing fee may be paid the Central Processor to cover the processing costs). The funding is based on the transaction records stored in the Central Database. Due to central processing and settlement, the billing and funding always reconcile, Merchants can perform additional reconciliation against their records.

Each Merchant receives one electronic fund transfer (or any other means of payment upon agreement) per funding period (Step 411-412), consisting of the sum of all accepted Electronic Coupons independent of Manufacturer origin and the product of the number of Electronic Coupons accepted times a part of the processing fee. With the funds transfer, the Merchant receives a funding period Reconciliation Report (Step 414) with summary such as the number of Electronic Coupons accepted and the number of products purchased to redeem those Electronic Coupons. In at least one embodiment, a detailed report of each Electronic Coupon accepted is also provided with the Reconciliation Report (415), including but not limited to the date and time of redemption, UPCs to which the Electronic Coupon was applied, Manufacturer identification, Electronic Coupon amount, and order and discount total amounts. Similar to the Manufacturer's invoice, the electronic format of the Merchant's Reconciliation Report allows for data reconciliation and manipulation without manual data entry.

In at least one embodiment of the invention, there is shown that participating Merchants, Manufacturers, and external entities outside of the Electronic Coupon System, such as marketing research firms, may order demographic, promotional, sales, product desirability or any other report as permitted by law. The reports are programmed and generated based on the Electronic Coupon redemption data combined with Manufacturer, Merchant and cardholder profiles stored in the Central Database. Personal information about the Electronic Coupon System participants (cardholders, Merchants, Manufacturers) is not released in reports unless permitted by law and the participant.

In at least one embodiment, a legal contract is made between the external entity and the Central Processor's Corporation in order to generate reports. Such a contract specifies requested data, report frequency, data limits, layout and other report parameters. The external entity is responsible for the exact definition of requested report. Multiple types of reports may be requested by the same entity.

When the external entity report requirements and Central Processor's fees are agreed upon via a contract, the report is generated and transmitted to the external entity in an electronic format or any other format as requested. In at least one embodiment, the external entity (31) functions as a “Neilsen” (Nielsen Media Research) like rating system for products, merchants, vendors and manufacturers. The external entity processor (31) compiles records including but not limited to merchant categories, specific merchants, specific manufacturers, and type of products, geographical data, or other data collected by the central entity or the external entity processor (31). The external entity processor (31) can use a sampling technique or if widely used can use its records as representative of market trends. In at least one embodiment, the data collected by the central entity is the primary source of statistical information used to survey market trends and patterns.

In at least one embodiment, at least some of the components of the electronic coupon system are designed according to ISO 8583 interface message specifications. In at least one embodiment, these message specifications are used in the interface between merchants and the central entity. The following explanation describes embodiments according to ISO 8583 Version 1.0 as of Jan. 23, 2004. Alternative embodiments are contemplated in which different ISO standards are used or alternatives commonly used in industry. In at least one embodiment, the electric coupon system is supported by TCP/IP protocol.

In at least one embodiment, the identifier is a credit card type electronic coupon (110 of FIG. 1C) which has a 16-digit account number embossed on the front of the card. In at least one embodiment, the cards are numbered according to the Mod-10 numbering scheme. The 16-th digit is a check digit, which is computed as follows:

Every digit in the card number is multiplied by a certain sequence of weights. The resulting products are added as single digits and then divided by 10. The remainder of the division must be equal to 0 in order for the card number to be valid.

Referring again to FIG. 1C there is shown a card in which a magnetic strip (50) is used for identification purposes. In at least one embodiment, the card has two or more tracks (51, 52, and 53). In at least one embodiment, track II is based on ISO/IEC 7811-2:2001 according to the following scheme (54):

| Field # | Length | Description and values | Binary (with parity bit) |
|---|---|---|---|
| 1 | 1 | Start sentinel, always “;” | 01011 |
| 2 | 16 | Card/account number | |
| 3 | 1 | Field Separator, always “=” | 01101 |
| 4 | 4 | Expiration Date | |
| 5 | 1 | End Sentinel, always “?” | 11111 |
| 6 | 1 | Longitudinal Redundancy | See below |
| | | Check | |

An odd parity algorithm is used to add a parity bit for each encoded character. In at least one embodiment, a longitudinal Redundancy Check (LRC) character is computed such that the sum of all bits in the same location of Track II characters is even. (Note: The parity bit in the LRC character is not included in this calculation, but refers only to the LRC character itself).

In at least one embodiment, the merchant utilizes a server with the following timeout settings: Acquiring Host: 40 sec and POS Device/Register: 45 sec. There are no off-line procedures after the timeout criteria have been reached. The register should display the appropriate timeout message to the cashier and customer. In at least one embodiment a higher than recommended timeout setting will allow for a greater chance to receive a response from the central entity.

A late response from the central entity could cause the customer's account to be erroneously updated with redeemed coupons, and not reflect on the current purchase total. The customer may then contact the central entity directly to rectify this matter. The central entity web server/website (42 in FIG. 1A) has a special procedure in place to process such claims automatically on-line.

In at least one embodiment the system will utilize response codes in reply to communications with the central entity. In at least one embodiment the system's response codes will utilize action codes that correspond with ISO 8583, Annex A table A.1. In at least one embodiment the action codes will populate field 39. In at least one embodiment the system will utilize at least some of the following action codes in reply to communications with the central entity:

| Code | Description | POS Action |
|---|---|---|
| 0000 | Approved | Approved for specified amount |
| 1018 | No Card Record | Invalid Account #, try again |
| 1009 | Invalid Card Acceptor | Denied, merchant to call for problem |
| | | resolution |
| 1019 | Transaction Not Permitted | No coupons on account, approved $0 |
| | to Cardholder | |
| 1000 | Do Not Honor | General Denial, format or other errors |

In at least one embodiment of the invention, data is transferred between the central entity (41) and a consumer, vendor, or merchant according in transactions. The transactions comprise at least alternating financial request and response messages. In at least one embodiment financial request messages will be parsed at least in part according to the following scheme:

Length: variable 106 bytes+

| Field # | Length | Data Type | Name | Values |
|---|---|---|---|---|
| 00 | 2 | Alpha | Message ID | “CP” - identifies a Coupons |
| | | | | Go Plastic transaction |
| 01 | 4 | Numeric | Service Code | “0200” - request |
| 02 | 16 | Numeric | PAN | Primary Account Number |
| | | | | Required when key-entered |
| 03 | 6 | Numeric | Processing | 000000 - scan coupons |
| | | | code | 000001 - reserved 1 |
| | | | | 000002 - reserved 2 |
| 04 | 16 | Numeric | Transaction | Right justified, implied |
| | | | amt | decimal amount, with leading |
| | | | | zeros as necessary to achieve |
| | | | | 8 digits |
| 11 | 12 | Numeric | System Trace | Unique transaction identifier |
| | | | Audit Number | (receipt number) |
| 12 | 14 | CCYYMMDDhhmmss | Local | Timestamp of POS time |
| | | | transaction | |
| | | | date and time | |
| 22 | 16 | Binary | POS data code | POS entry mode: swiped |
| | | | | (020) or key-entered (010) |
| 26 | 4 | Numeric | Merchant | Classification of merchant's |
| | | | category code | business type (ISO 18245) |
| 35 | 24 | Numeric, special | Track II data | Track II data in format |
| | | | | specified above |
| 41 | 16 | Alphanumeric | Card acceptor | First four digits identify the |
| | | | Terminal ID | store number, last four digits |
| | | | | identify the terminal or POS |
| | | | | device |
| 42 | 11 | Alphanumeric | Card acceptor | Merchant # |
| | | | ID code | |
| 104L | 4 | Numeric | Length | 4 digit length of element 104, |
| | | | | with leading zeros |
| 104 | 1 . . . 9999 | Alphanumeric, special | Transaction | Numeric UPC codes, |
| | | | Specific Data | separated by commas |

In at least one embodiment, the central entity distributes a list of discounted UPC codes on a periodic basis to the merchant. For the purposes of this application, the term “discounted UPC” is defined as a Universal Product Code (UPC), for which there exists a manufacturer's discount or coupon. In one embodiment, the merchant is responsible for appropriately marking all discounted UPC codes in its Item File (Note: Merchant's Item File might contain only a subset of discounted UPC codes on the distribution list).

In at least one embodiment, during a single order, when a discounted UPC is scanned at the Point Of Sale, the software must buffer it for possible future use in a separate array until the order is complete. For multiple quantities of the same product, the same UPC must be buffered multiple times. If the order is complete and the Coupon Card has not been scanned, the buffer must be discarded at that time until the next order. If the Coupon Card is scanned, all of the buffered discounted UPCs must be inserted into field 104 of the Financial Request message, separated by some recognized delimiter (such as commas or tab keys) and ending with a period (or other terminator as detailed in Transaction Format section).

In at least one embodiment, the merchant does not know which UPCs are discounted. When the Coupon Card is scanned, all of the UPCs in the order are inserted into field 104 of the Financial Request (14) message, separated by delimiters such as commas or tabs and ending with a period or other terminator. For multiple quantities of the same product, the same UPC must be entered multiple times. The central entity may not be able retain the order information for Merchant's privacy, with the exception of the discounted UPCs.

Financial response messages (15) are generated in reply to financial request messages (14). In at least one embodiment financial response messages will be parsed at least in part according to the following scheme:

Length: fixed 112 bytes

| Field # | Length | Data Type | Name | Values |
|---|---|---|---|---|
| 00 | 2 | Alpha | Message ID | “CP” - identifies a Coupons |
| | | | | Go Plastic transaction |
| 01 | 4 | Numeric | Service Code | “0210” - response |
| 02 | 16 | Numeric | PAN | Primary Account Number |
| | | | | Echo |
| 03 | 6 | Numeric | Processing | 000000 - scan coupons |
| | | | code | 000100 - reserved 1 |
| | | | | 000200 - reserved 2 |
| | | | | Echo |
| 04 | 16 | Numeric | Approved amt | Right justified, implied |
| | | | | decimal amount, with leading |
| | | | | zeros as necessary to achieve |
| | | | | 8 digits. Represents approved |
| | | | | amount to be taken off order |
| 11 | 12 | Numeric | System Trace | Unique transaction identifier |
| | | | Audit Number | (receipt number) |
| | | | | Echo |
| 12 | 14 | CCYYMMDDhhmmss | Local | Timestamp of POS time |
| | | | transaction | Echo |
| | | | date and time | |
| 22 | 16 | Binary | POS entry | Swiped or key-entered |
| | | | mode | Echo |
| 35 | 24 | Numeric | Track II data | Track II data in format |
| | | | | specified above |
| | | | | Echo |
| 38 | 6 | Alphanumeric | Approval Code | Auth code |
| 39 | 4 | Numeric | Action Code | Response Code |
| 41 | 16 | Alphanumeric | Card acceptor | First four digits identify the |
| | | | Terminal ID | store number, last four digits |
| | | | | identify the terminal or POS |
| | | | | device |
| | | | | Echo |
| 42 | 11 | Numeric | Card acceptor | Merchant # |
| | | | ID code | Echo |
| 54 | 126 | Alphanumeric | Amounts | Constructed field for food |
| | | | Additional | only coupon amounts |

In at least one embodiment, all data elements contained in Financial Request and Response messages are mandatory which make bitmaps unnecessary.

In at least one embodiment, the financial response message contains two amounts, one designating the total value of coupons used and one designating the value of coupons being used for food purchases. Keeping separate track of food purchases allows the electronic coupon to be used for food assistance programs such as food stamps, AFDC, Link, and other government or non-profit programs in which needy persons are provided with subsidies to assist with food purchases. In at least one embodiment, the central entity or the external entity processor maintains and reviews records as to the eligibility of the customer for food assistance and automatically either offers food coupons to those deemed eligible or invalidates coupons to those deemed ineligible. The system can also distinguish between market based food sales and subsidy based food sales for statistical purposes.

In at least one embodiment, field 4 keeps track of the total numbers, value, or amount of electronic coupons used in a transaction, and field 54 specifies the number, value, or amount of coupons used for a specific kind of purchase (such as food or subsidy sales). As a validation step, if field 54 is greater than field 4 an error is present. Typically field 4 minus field 54 will provide the non subsidized sale amount. In at least one embodiment, field 54 has a length of 0-126, is alphanumeric, has a name of additional amounts, and has values of constructed field for food only coupons.

The system can also be designed to keep separate track of other specific kinds of transactions such as health spending allowing the electronic coupon system to be used with HSA or health insurance programs or to keep track of any of the kind of merchant category codes listed in the following ISO 18245

In at least one embodiment, field 26 of the Financial Request message is a four digit merchant category code utilizing the following ISO 18245 scheme:

X=Not Blocked from Use

All Others Blocked

| X | MCC | Group Description |
|---|---|---|
| | | Group I - Contracted Services |
| | | All Contracted Services (0742-2842) |
| | 0742 | Veterinary Services |
| | 0763 | Agricultural Cooperatives |
| | 0780 | Horticultural and Landscaping Services |
| | 1520 | General Contractors Residential and Commercial |
| | 1711 | Air Conditioning, Heating, Plumbing Contractors |
| | 1731 | Electrical Contractors |
| | 1740 | Insulation, Masonry, Plastering, Stonework, Tile |
| | 1750 | Carpentry Contractors |
| | 1761 | Roofing and Siding, Sheet Metal Work Contractors |
| | 1771 | Concrete Work Contractors |
| | 1799 | Contractors, Special Trade (Not Elsewhere Classified) |
| | 2741 | Miscellaneous Publishing and Printing |
| | 2791 | Typesetting, Plate Making, and Related Services |
| | 2842 | Specialty Cleaning, Polishing |
| | | Group II - Travel and Entertainment |
| | | All Airlines (3000-3299) |
| | | All Rental Agencies (3351-3440) |
| | | All Hotels (3501-3744) |
| | | All Entertainment Providers (7829-7999) |
| | 7829 | Motion Picture and Video Tape Production |
| | 7832 | Motion Picture Theaters |
| | 7841 | Video Tape Rental Stores |
| | 7911 | Dance Halls, Schools, and Studios |
| | 7922 | Theatrical Producers Ticket Agencies |
| | 7929 | Bands, Orchestras, and Misc. Entertainers |
| | | (Not Elsewhere Classified) |
| | 7932 | Billiard and Pool Establishments |
| | 7933 | Bowling Alleys |
| | 7941 | Athletic Fields, Commercial Sports, etc. |
| | 7992 | Golf Courses, Public |
| | 7994 | Video Game Arcades/Establishments |
| | 7995 | Betting |
| | 7996 | Amusement Parks, Carnivals, etc. |
| | 7997 | Clubs, Country Clubs, Membership, etc. |
| | 7998 | Aquariums, Dolphinariums, and Seaquariums |
| | 7999 | Recreation Services (Not Elsewhere Classified) |
| | | Group III - Transportation, Vehicle and Repair |
| | | Transportation (Commuter/Public) (4011-4789) |
| | | Transportation (Personal) (5511-5599) |
| | | Vehicle and Repair (Miscellaneous) (7531-7699) |
| | 4011 | Railroads |
| | 4111 | Transportation Commuter Passenger |
| | 4112 | Passenger Railways |
| | 4119 | Ambulance Services |
| | 4121 | Limousines and Taxicabs |
| | 4131 | Bus Lines |
| X | 4214 | Motor Freight Carriers, Trucking |
| X | 4215 | Courier Services Air and Ground, Freight Forwarders |
| X | 4225 | Public Warehousing |
| | 4411 | Cruise Lines |
| | 4457 | Boat Leases and Boat Rentals |
| | 4668 | Marinas, Marine Service/Supplies |
| | 4511 | Air Carriers, Airlines |
| | 4582 | Airports, Airport Terminals, Flying Fields |
| | 4722 | Travel Agencies and Tour Operators |
| | 4784 | Bridge and Road Fees, Tolls |
| | 4789 | Transportation Services (Not Elsewhere Classified) |
| | 5511 | Automobile and Truck Dealers |
| | 5521 | Automobile and Truck Dealers (Used Only) Sales |
| | 5531 | Auto Store, Home Supply Stores |
| | 5532 | Automotive Tire Stores |
| | 5533 | Automotive Parts, Accessories Stores |
| | 5541 | Service Stations (With or Without Ancillary Services) |
| | 5542 | Fuel Dispenser, Automated |
| | 5551 | Boat Dealers |
| | 5561 | Camper Dealers, Recreational and Utility Trailers |
| | 5571 | Motorcycle Shops and Dealers |
| | 5592 | Motor Home Dealers |
| | 5598 | Snowmobile Dealers |
| | 5599 | Miscellaneous Automotive, Aircraft and Farm |
| | | Equipment Dealers (Not Elsewhere Classified) |
| | 7531 | Automotive Body Repair Shops |
| | 7534 | Tire Re-treading and Repair Shops |
| | 7535 | Automotive Paint Shops |
| | 7538 | Automotive Service Shops (Non-dealer) |
| | 7542 | Car Washes |
| | 7549 | Towing Services |
| | 7622 | Electronic Repair Shops |
| | 7623 | Air Conditioning and Refrigeration Repair Shops |
| | 7629 | Appliance Repair Shops, Electrical and Small |
| | 7631 | Clock, Jewelry, and Watch Repair Shops |
| | 7641 | Furniture Re-upholstery and Repair, Refinishing |
| | 7692 | Welding Repair |
| | 7699 | Miscellaneous Repair Shops and Related Services |
| | | Group IV - Services |
| | | Services (Utilities) (4812-4900) |
| | | Services (Providers) (6010-7033) |
| | | Services (Personal Care) (7210-7299) |
| | | Services (Business) (7311-7523) |
| | | Services (Professional/Organizations) (8011-8999) |
| | | Services (Government) (9211-9402) |
| X | 4812 | Telecommunication Equipment |
| | 4814 | Telecommunication Service |
| | 4815 | MasterPhone Telephone Service |
| | 4816 | Computer Network/Information Services |
| | 4819 | Telecommunications |
| | 4821 | Telegraph Services |
| | 4829 | Wire Transfer, Money Orders (WTMO's) |
| | 4899 | Cable and other Pay Television Services |
| X | 4900 | Utilities Electric, Gas, Sanitary, Water |
| | 6010 | Financial Institutions Manual Cash Disbursements |
| | 6011 | Financial Institutions Automated Cash |
| | 6012 | Financial Institutions Merchandise and Services |
| | 6051 | Non Financial Institutions |
| | 6211 | Securities Brokers/Dealers |
| | 6300 | Insurance Sales, Underwriting, and Premiums |
| | 7011 | Lodging Hotels, Motels, Resorts |
| | 7012 | Timeshares |
| | 7032 | Recreational and Sporting Camps |
| | 7033 | Campgrounds and Trailer Parks |
| | 7210 | Cleaning, Garment, and Laundry Services |
| | 7211 | Laundry Services Family and Commercial |
| | 7216 | Dry Cleaners |
| | 7217 | Carpet and Upholstery Cleaning |
| | 7221 | Photographic Studios |
| | 7230 | Barber and Beauty Shops |
| | 7251 | Hat Cleaning Shops, Shoe Repair, Shoe Parlors |
| | 7261 | Funeral Service and Crematories |
| | 7273 | Dating and Escort Services |
| | 7276 | Tax Preparation Service |
| | 7277 | Debt, Marriage, Personal Counseling Service |
| | 7278 | Buying/Shopping Clubs, Services |
| | 7295 | Babysitting Services |
| | 7296 | Clothing Rentals Costumes, Uniforms |
| | 7297 | Massage Parlors |
| | 7298 | Health and Beauty Spas |
| | 7299 | Other Services (Not Elsewhere Classified) |
| | 7311 | Advertising Services |
| | 7321 | Consumer Credit Reporting Agencies |
| | 7333 | Commercial Art, Graphics, Photography |
| | 7338 | Quick Copy, Reproduction, and Blueprint Services |
| | 7339 | Stenographic and Secretarial Support Services |
| | 7342 | Exterminating and Disinfecting Services |
| | 7349 | Cleaning and Maintenance, Janitorial Services |
| | 7361 | Employment Agencies, Temporary Help Services |
| | 7372 | Computer Programming, Data Processing |
| | 7375 | Information Retrieval Services |
| | 7379 | Computer Maintenance, Repair, and Services |
| | 7392 | Consulting, Management, and Public Relations |
| | 7393 | Detective Agencies, Protective Agencies |
| | 7394 | Equipment Rental, Leasing, Furniture Tool Rental |
| | 7395 | Photo Developing, Photo finishing Laboratories |
| | 7399 | Business Services (Not Elsewhere Classified) |
| | 7511 | Truck Stop Transactions |
| | 7512 | Automobile Rental Agency |
| | 7513 | Truck and Utility Trailer Rental |
| | 7519 | Motor Home and Recreational Vehicle Rental |
| | 7523 | Automobile Parking Lots and Garages |
| | 8011 | Doctors (Not Elsewhere Classified) |
| | 8021 | Dentists, Orthodontists |
| | 8031 | Osteopathic Physicians |
| | 8041 | Chiropractors |
| | 8042 | Optometrists, Ophthalmologists |
| | 8043 | Opticians, Optical Goods, and Eyeglasses |
| | 8049 | Chiropodists, Podiatrists |
| | 8050 | Nursing and Personal Care Facilities |
| | 8062 | Hospitals |
| | 8071 | Dental and Medical Laboratories |
| | 8099 | Health Practitioners, Medical Services |
| | 8111 | Attorneys, Legal Services |
| | 8211 | Schools, Elementary and Secondary |
| | 8220 | Colleges, Universities, Professional Schools |
| | 8241 | Schools, Correspondence |
| | 8244 | Schools, Business and Secretarial |
| | 8249 | Schools, Trade and Vocational |
| | 8299 | Schools and Educational Services |
| | 8351 | Child Care Services |
| | 8398 | Organizations, Charitable and Social Service |
| | 8641 | Associations Civic, Social, and Fraternal |
| | 8651 | Organizations, Political |
| | 8661 | Organizations, Religious |
| | 8675 | Associations, Automobile |
| X | 8699 | Organizations, Membership |
| | 8734 | Testing Laboratories (Non-Medical) |
| | 8911 | Architectural, Engineering, and Surveying Service |
| | 8931 | Accounting, Auditing, and Bookkeeping Services |
| | 8999 | Professional Services (Not Elsewhere Classified) |
| | 9211 | Court Costs including Alimony and Child Support |
| | 9222 | Fines |
| | 9223 | Bail and Bond Payments |
| | 9311 | Tax Payments |
| X | 9399 | Government Services (Not Elsewhere Classified) |
| | 9402 | Postal Services - Government ONLY |
| | | Group V - Retail Stores |
| | | Retail Stores (Miscellaneous) (5013-5499) |
| | | Retail Stores (Clothing) (5611-5697) |
| | | Retail Stores (Other) (5698-5999) |
| | 5013 | Motor Vehicle Supplies and New Parts |
| X | 5021 | Office and Commercial Furniture |
| X | 5039 | Construction Materials (Not Elsewhere Classified) |
| X | 5044 | Office, Photographic, Photocopy |
| X | 5045 | Computers, Computer Peripheral Equipment, Software |
| X | 5046 | Commercial Equipment (Not Elsewhere Classified) |
| X | 5047 | Dental/Laboratory/Medical/Ophthalmic |
| X | 5051 | Metal Service Centers and Offices |
| X | 5065 | Electrical Parts and Equipment |
| X | 5072 | Hardware Equipment and Supplies |
| X | 5074 | Plumbing and Heating Equipment |
| X | 5085 | Industrial Supplies (Not Elsewhere Classified) |
| | 5094 | Precious Stones and Metals, Watches and Jewelry |
| X | 5099 | Durable Goods (Not Elsewhere Classified) |
| X | 5111 | Stationery, Office Supplies, Printing |
| | 5122 | Drugs, Drug Proprietors, and Druggists Sundries |
| X | 5131 | Piece Goods, Notions, and Other Dry Goods |
| X | 5137 | Men's, Women's, and Children's Uniforms |
| X | 5139 | Commercial Footwear |
| X | 5169 | Chemicals and Allied Products |
| X | 5172 | Petroleum and Petroleum Products |
| X | 5192 | Books, Periodicals and Newspapers |
| X | 5193 | Florists Supplies, Nursery Stock, and Flowers |
| X | 5198 | Paints, Varnishes and Supplies |
| X | 5199 | Non-durable Goods (Not Elsewhere Classifieds) |
| X | 5200 | Home Supply Warehouse |
| X | 5211 | Building Materials, Lumber Stores |
| X | 5231 | Glass, Paint, Wallpaper Stores |
| X | 5251 | Hardware Stores |
| X | 5261 | Lawn and Garden Supply Stores |
| | 5271 | Mobile Home Dealers |
| X | 5300 | Wholesale Clubs |
| | 5309 | Duty Free Stores |
| X | 5310 | Discount Stores |
| X | 5311 | Department Stores |
| X | 5331 | Variety Stores |
| X | 5399 | Miscellaneous General Merchandise |
| | 5411 | Grocery Stores, Supermarkets |
| | 5422 | Freezer, Locker Meat Provisioners |
| | 5441 | Candy, Nut, Confectionery Stores |
| | 5451 | Dairy Products Stores |
| | 5462 | Bakeries |
| | 5499 | Miscellaneous Food Stores |
| | 5611 | Men's and Boy's Clothing and Furnishings Store |
| | 5621 | Women's Ready to Wear Stores |
| | 5631 | Women's Accessory and Specialty Stores |
| | 5641 | Children's and Infants' Wear Stores |
| | 5651 | Family Clothing Stores |
| | 5655 | Sports Apparel, Riding Apparel Stores |
| X | 5661 | Shoe Stores |
| | 5681 | Furriers and Fur Shops |
| | 5691 | Men's and Women's Clothing Stores |
| | 5697 | Alterations, Mending, Seamstresses, Tailors |
| | 5698 | Wig and Toupee Shops |
| | 5699 | Accessory and Apparel Stores Miscellaneous |
| X | 5712 | Equipment, Furniture, and Home Furnishings Stores |
| X | 5713 | Floor Covering, Rug and Carpet Stores |
| X | 5714 | Drapery, Upholstery, and Window Coverings Stores |
| X | 5718 | Fireplace, Fireplace Screens, Accessories Stores |
| X | 5719 | Miscellaneous House Furnishing Specialty Shops |
| | 5722 | Household Appliance Stores |
| X | 5732 | Electronics Sales |
| X | 5733 | Music Stores |
| X | 5734 | Computer Software Stores |
| X | 5735 | Record Shops |
| | 5811 | Caterers |
| | 5812 | Eating Places, Restaurants |
| | 5813 | Bars, Cocktail Lounges, Discotheques, etc. |
| | 5814 | Quick Payment Service Fast-Food Restaurants |
| | 5912 | Drug Stores, Pharmacies |
| | 5921 | Package Stores, Beer, Wine, Liquor |
| | 5931 | Second Hand Stores, Used Merchandise Stores |
| | 5932 | Antique Shops - Sales, Repairs, and Restoration Services |
| | 5933 | Pawn Shops |
| | 5935 | Wrecking Yards |
| | 5937 | Antique Reproduction Stores |
| | 5940 | Bicycle Shops Sales and Service |
| | 5941 | Sporting Goods Stores |
| X | 5942 | Book Stores |
| X | 5943 | Office, School Supply, and Stationery Stores |
| | 5944 | Clock, Jewelry, Watch, and Silverware Stores |
| | 5945 | Game, Toy, and Hobby Shops |
| X | 5946 | Camera and Photographic Supply Stores |
| | 5947 | Card, Gift, Novelty, and Souvenir Shops |
| | 5948 | Leather Goods and Luggage Stores |
| | 5949 | Fabric, Needlework, Piece Goods, and Sewing Stores |
| | 5950 | Crystal and Glassware Stores |
| | 5960 | Direct Marketing - Insurance Services |
| | 5961 | Mail Order Catalogs (Non-US) |
| | 5962 | Direct Marketing - Travel Related Arrangement Services |
| | 5963 | Door-to-Door Sales |
| X | 5964 | Direct Marketing - Catalog Merchants |
| X | 5965 | Direct Marketing - Combination-Catalog and Retail |
| | | Merchants |
| | 5966 | Direct Marketing - Outbound Telemarketing Merchants |
| | 5967 | Direct Marketing - Inbound Teleservices Merchants |
| X | 5968 | Direct Marketing - Continuity/Subscription Merchants |
| | 5969 | Direct Marketing - Other Direct Marketers |
| | | (Not Elsewhere Classified) |
| X | 5970 | Artist Supply Stores, Craft Shops |
| | 5971 | Art Dealers and Galleries |
| | 5972 | Stamp and Coin Stores Philatelic and Numismatic |
| | 5973 | Religious Goods Stores |
| | 5975 | Hearing Aids Sales, Service, Supply Stores |
| | 5976 | Orthopedic Goods Artificial Limb Stores |
| | 5977 | Cosmetic Stores |
| X | 5978 | Typewriter Stores, Rentals, Sales, Service |
| | 5983 | Fuel Dealers Coal, Fuel Oil, Liquefied Petroleum |
| | 5992 | Florists |
| | 5993 | Cigar Stores and Stands |
| X | 5994 | News Dealers and Newsstands |
| X | 5995 | Pet Shops Pet Food and Supplies |
| | 5996 | Swimming Pools Sales and Supplies |
| | 5997 | Electric Razor Stores Sales and Service |
| | 5998 | Tent and Awning Shops |
| | 5999 | Miscellaneous and Specialty Retail Stores |
| | | Group VI - International |
| | | All International (UK) (9751-9752) |
| | 9751 | UK Supermarkets, Electronic Hot File |
| | 9752 | UK Petrol Stations, Electronic Hot File |

This completes the description of the preferred and alternate embodiments of the invention. The above disclosure is intended to be illustrative and not exhaustive. This description will suggest many variations and alternatives to one of ordinary skill in this art. The various elements shown in the individual figures and described above may be combined, substituted, or modified for combination as desired. In particular it will be recognized that the various formatted data messages can have their fields differ at least in length, data type, order, field number, name, and message ID from those previously recited. In addition it is also recognized that the various lengths are potential maxima but in fact fields having greater or smaller lengths are contemplated by this invention. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claims below.

1. A system for allocating price discounts to consumers comprising:
a central entity and a POS system in informational communication with each other; wherein:
the POS system is constructed and arranged to receive a consumer identifier from at least one consumer during a transaction, to format and transmit a discount request to the central entity for validation, to receive a discount reply from the central entity, and to appropriately process the transaction based on the discount reply;
the transmitted discount request comprises an account identifier and at least one discount identifier;
the central entity has at least two files, an account file and a discount file and is constructed and arranged to receive the discount request, validate the account identifier against one or more values in the account file, validate the discount request against one or more values the discount file, and transmit a discount reply to the POS system,
the discount file having at least one entry comprising at least one product identifier and at least one amount associated with the product identifier;
the account file being associated with at least one entry in the discount file;
the transmitted discount reply contains at least one of the following indicators: valid and invalid,
the POS system is also constructed and arranged to issue the consumer a discount equal to the amount indicated to be valid in the discount reply.

2. The system of claim 1 in which at least one of the two files is within at least one relational database.

3. The system of claim 2 in which the informational communication is one selected from the list consisting of file transfer protocol, internet access, access through a webpage, e-mail, and any combination thereof.

4. The system of claim 2 in which the consumer identifier is selected from the list consisting of a card, a PVC card, a USB drive, a password, personal data cross referenced in a file in the relational database, and identical to the account identifier.

5. The system of claim 1 in which the consumer identifier is a PVC card having at least one magnetic stripe which the POS system is constructed and arranged to read when swiped.

6. The system of claim 5 in which the PVC card has three tracks, an upper track, a lower track, and a middle track between the other two tracks, the tracks constructed and arranged according to ISO 7811 standards, in which the middle track comprises the following fields: a start sentinel, the account identifier, a field separator, a four digit expiration date, discretionary data, an end sentinel, and a longitude redundancy check field.

7. The system of claim 1 in which the discount identifier is one item selected from the list consisting of, the numerical value of the UPC of a product being purchased by the customer, the name of a product being purchased by the customer, and a numerical code assigned to a particular product being purchased by the customer.

8. The system of claim 1 in which the central entity is also constructed and arranged to be in informational communication with a computer operated by a customer and in which the customer can log into the central entity and update at least a portion of their account in the accounts file.

9. The system of claim 8 in which the central entity is constructed and arranged to create an account for a customer by undergoing the following steps:
receive an electronic transmission from a customer;
prompt the consumer to provide information;
assign an account number;
and create an entry in the account file for a new account which is related to the assigned account number.

10. The system of claim 8 in which the central entity is constructed and arranged to allow a logged on customer to browse through at least some of the data in the discounts file and reversibly select particular entries in the discount file, such selected discount file entries thus become associated with the customer's account.

11. The system of claim 1 in which the central entity is in informational communication with at least one product vendor, the central entity constructed and arranged to allow a product vendor to reversibly add entries to the discounts file.

12. The system of claim 1 in which the transmitted discount request is at least 106 bytes long in which:
field 00 is 2 alphabetical characters long and containing “CP” which indicates that the transmission is an electronic coupon transaction;
field 01 is 4 numeric characters long and is a service code;
field 02 is 16 numeric characters long and includes a primary account number;
field 03 is 6 numeric characters long and includes a processing code;
field 04 is 16 numeric characters long and includes a transaction amount;
field 11 is 12 numeric characters long and includes a system trace audit number;
field 12 is 14 alphanumeric characters and includes a timestamp of POS time;
field 22 is binary 16 numeric characters long and includes a code for the manner of POS data entry;
field 26 is 4 numeric characters long and includes a merchant category code according to ISO 18245 standards;
field 35 is 25 special numeric characters long and includes the consumer identifier provided by the consumer;
field 41 is 16 alphanumeric characters long and includes an identifier of the POS system;
field 42 is 11 alphanumeric characters long and includes a merchant ID#;
field 104L is the first 4 numeric characters of field 104 and provides the zero led length of field 104;
field 104 variable length and includes delineated product codes.

13. The system of claim 1 in which the transmitted discount reply is at least 112 bytes long in which:
field 00 is 2 alphabetical characters long and include the characters “CP” which indicates that the transmission is an electronic coupon transaction;
field 01 is 4 numeric characters long and includes a service code of “0210”;
field 02 is 16 numeric characters long and includes a primary account number;
field 03 is 6 numeric characters long and includes a processing code;
field 04 is 8 numeric characters long and includes an approved transaction amount;
field 11 is 6 numeric characters long and includes a system trace audit number;
field 12 is 14 alphanumeric characters and includes a timestamp of POS time;
field 22 is 3 numeric characters long and includes a code for the manner of POS data entry;
field 35 is 25 special numeric characters long and includes the consumer identifier provided by the consumer;
field 41 is 8 alphanumeric characters long and includes an identifier of the POS system;
field 42 is 11 alphanumeric characters long and includes a merchant ID#; and
field 54 is selected from the range consisting of 1-126 alphanumeric characters long and includes a value of coupons only used for food.

14. The system of claim 1 in which the transmitted discount request conforms to ISO 8583 standards.

15. The system of claim 1 in which the system filters transactions according to their ISO 18245 merchant code and it maintains separate records of transactions involving at least one such merchant code.

16. A system for allocating price discounts to consumers comprising:
a central entity, a external entity requester, at least one manufacturer, and a POS system in informational communication with each other; wherein:
the POS system is constructed and arranged to receive a consumer identifier from at least one consumer during a transaction, to format and transmit a discount request to the central entity for validation, to receive a discount reply from the central entity, and to appropriately process the transaction based on the discount reply;
the transmitted discount request comprises an account identifier and at least one discount identifier;
the central entity has at least two files, an account file and a discount file and is constructed and arranged to receive the discount request, validate the account identifier against one or more values in the account file, validate the discount request against one or more values the discount file, and transmit a discount reply to the POS system,
the discount file having at least one entry comprising at least one product identifier and at least one amount associated with the product identifier;
the account file being associated with at least one entry in the discount file;
the transmitted discount reply contains at least one of the following indicators: valid and invalid,
the at least one manufacturer comprises a computer in informational communication with the discount file and is constructed and arranged to reversibly add, subtract, and modify, product identifiers and amounts in the discount file,
the POS system is also constructed and arranged to issue the consumer a discount equal to the amount indicated to be valid in the discount reply,
the external entity requester receive records of discounts allocated by the system.

17. The system of claim 16 in which the records received by the external entity requester are sorted and rated according to one attribute selected form the list consisting of product sales, product promotions, manufacturer, merchant, vendor, consumer type, geographical location of sale product type, product identifier, and any combination thereof.

18. A method of electronically allocating price discounts to consumers during a transaction comprising:
providing a central entity and a POS system in informational communication with each other; wherein:
the POS system is constructed and arranged to receive a consumer identifier from at least one consumer during a transaction, to format and transmit a discount request to the central entity for validation, to receive a discount reply from the central entity, and to appropriately process the transaction based on the discount reply;
the transmitted discount request comprises an account identifier and at least one discount identifier;
the central entity has at least two files, an account file and a discount file and is constructed and arranged to receive the discount request, validate the account identifier against one or more values in the account file, validate the discount request against one or more values the discount file, and transmit a discount reply to the POS system,
the discount file having at least one entry comprising at least one product identifier and at least one amount associated with the product identifier;
the account file being associated with at least one entry in the discount file;
the transmitted discount reply contains at least one of the following indicators: valid and invalid,
the POS system is also constructed and arranged to issue the consumer a discount equal to the amount indicated to be valid in the discount reply;
formatting a discount request;
transmitting the discount request from the POS system to the central entity;
validating the discount request;
formatting a discount reply;
transmitting the discount reply from the central entity to the POS system;
appropriately adjusting the sale price of the transaction according to the validated discount amount.

19. The method of claim 18 in further comprising the steps of:
registering a customer within the accounts file; and
selecting at least one discount from the discount file.

20. The method of claim 18 in further comprising the steps of:
storing information generated during the transaction in an archive file;
rating at least some of the stored information according to one attribute selected from the list consisting of: customer type, manufacturer, manufacturer type, product, product type, sale location, sale amount, price, point of sale, location, customer location, method of payment, and any combination thereof.
